(19) United States
(12) Patent Application Publication
(10) Pub. No.: US 2002/0154017 A1
(43) Pub. Date: Oct. 24, 2002

(54) Inventory management system for admixtures and additives for concrete, grout and mortar

(75) Inventor: William Terry Farner, St. Petersburg, FL (US)

Correspondence Address: JOSEPH G CURATOLO, ESQ., RENNER KENNER GREIVE BOBAK TAYLOR & WEBER, 24500 CENTER RIDGE ROAD, SUITE 280, WESTLAKE, OH, 44145, US

(73) Assignee: MBT Holding AG, Zurich (CH)

(21) Appl. No.: 10/108,313

(22) Filed: Mar. 28, 2002

Related U.S. Application Data
(60) Provisional application No. 60/281,442, filed on Apr. 4, 2001.

(51) Int. Cl. G08B 21/00

(52) U.S. Cl. 340/612; 709/104; 340/825.29; 340/539

(57) ABSTRACT

A method of managing inventory of admixture and additive material for concrete, grout and mortar in storage containers at remote locations is provided. A level indicator inventories the storage containers. The level or volume of material in the storage container is determined and transmitted to a database via a wireless system. The database can be queried to determine if material needs to be shipped to the storage container. If needed, an order is generated to ship material to the storage container.

### CROSS REFERENCE TO RELATED APPLICATIONS

This application claims the benefit of the filing date of U.S. Provisional Application for Patent Serial No. 60/281,442, filed Apr. 4, 2001.

### BACKGROUND OF THE INVENTION

On site storage containers for raw materials may be placed at varying locations. Currently, a person must travel to the storage containers to measure the volume of material in the container in order to determine if additional material should be shipped to the storage containers. This has been a labor and time intensive procedure, particularly when the storage containers are dispersed over a wide geographic area.

In the concrete admixture and additive industry, this is particularly a labor and time intensive procedure. Typically in the concrete admixture and additive industry, a plurality of storage containers is leased from the supplier of the admixture and additive materials. Typical admixtures include air-entraining agents, air detraining agents, set accelerators, set retarders, foaming agents, corrosion inhibitors, and cement dispersing or water reducing agents, among others. Depending upon seasonal or climatic variations in temperature, different amounts and types of admixtures are added to a cementitious formulation in order to achieve a desired strength and set time. As a result, there may be times of high demand or low demand for a given admixture based on seasonal or climatic variation. For example, in warmer climates, such as during the summer, retarders are added to cementitious mixtures to prevent the mixture from setting until it is placed. During the winter months, accelerators are used to cause the mixture to set more rapidly.

Generally, a salesperson will inventory the storage containers while making sales calls on customers in the salesperson's territory. This reduces the time that a salesperson can spend with a customer. Additionally, a salesperson may have to make repeated trips to the customer during periods of high consumption of materials from the storage containers.

Once the storage containers are inventoried, orders to send material to the storage containers are then placed with a distribution facility based on the current amount in the storage container and whether the storage container is at a normal reorder level or at a critical inventory level. A normal reorder level is an amount needed based on experience of usage and projected availability and delivery time to maintain supply for normal projected usage. A critical inventory level is based on unusual demand or some other event that has depleted the supply beyond normal projected usage and must be replaced for maintaining supply. Occasionally, orders are placed before a reorder level is reached. This happens because the storage container is inventoried while a person is at the location. That person may not be scheduled to come back to that location for several days. An order may be placed based on the current level in the storage container and a projected use of material.

Occasionally, from the time the order is placed and when material arrives at the storage container, the need for the material may have changed from the projected use amount. This may mean that there is not enough available space in the storage container to unload the full amount of ordered material. The amount of material that did not get unloaded is generally returned to the manufacturer. If possible, the small portion of material may be shipped to a storage container in another location that has available space. This, however, is a time consuming process for a person to check the status of other storage containers to determine whether these other storage containers can accommodate the material, and whether the customer approves the delivery.

Returning the material to the manufacturer or to another storage container incurs additional shipping charges. Also, the customer's invoiced amount has to be changed to reflect the actual amount of material received. Typically, it can take up to several days for the information concerning the actual amount delivered to a storage container to be routed to an accounting department that thereafter prepares an invoice to be sent to the customer. Information about the amount delivered is taken from the shipping vehicle back to the shipper's terminal. The shipper then sends the information to the accounting department to prepare the invoice.

The delay in the time to obtain information about the amount of material that was delivered to the storage container and to translate the information into an invoice to be sent to a customer means that working capital is increased. Resources, such as raw materials and labor, are committed to manufacturing material. The longer the time it takes to be paid for the material, means that more working capital is needed to cover these costs. Preferably, a manufacturer would want to be paid immediately for the production of material. Also, the potential additional shipping charges for returned or re-routed material resulting from having shipped too much material initially to the storage container decreases profits and may disrupt production, for example, if the material had to be manufactured out of sequence in the manufacturing production schedule to accommodate the order.

What is needed is a system that can provide accurate and up to date inventory information for remote storage containers, without the need of having a person actually go to each location and inventory the storage containers.

It is therefore desirable to provide an inventory management system for admixtures and additives for concrete, grout and mortar, that provides up to date inventory of remote storage containers, that is optionally capable of integration with manufacturing, delivery, and accounts receivable systems.

### SUMMARY OF THE INVENTION

The present invention is directed to a method of measuring the volume of admixture or additive material in a storage container, and then supplying additional material to the storage container based on the volume in the storage container. More particularly, in one embodiment, the invention includes measuring the volume of material in the storage container, transmitting data representing the volume via a wireless system to a receiver, and determining the amount of additional material to be supplied based upon the data and rules established for demand of material.

The present invention provides a method of managing inventory of admixture and additive material for concrete, grout and mortar remotely, comprising a) inventorying a first at least one storage container of material at a remote site to provide a material volume present comprising i) measuring a level of material in the first at least one storage container with an electronic level indicator to provide a signal representative of the container level; ii) transmitting the signal representative of the container level from the electronic level indicator to a first processor; wherein said measuring is performed at one of a preset time and on demand; and, performing one of step b) or step c) as follows: b) i) processing the signal representative of the container level to determine the material volume present in the first at least one storage container; and ii) transmitting data representing the material volume present in the first at least one storage container from the first processor to a second processor via one of cellemetry and satellite; or c) i) transmitting the signal representative of the container level in the first at least one storage container from the first processor to a second processor via one of cellemetry and satellite; and ii) processing the signal representative of the container level to determine the material volume present in the first at least one storage container; and, d) storing data representing the material volume present, a predetermined reorder level, and a predetermined critical level in a database associated with the second processor.

In one embodiment, the method further comprises querying the database to determine if material needs to be shipped to the first at least one storage container based on the material volume present. In one embodiment, the method further comprises generating an order to ship material to the first at least one storage container, and transmitting the order to ship material automatically or after authorization. In one embodiment, generating the order to ship material occurs if the material volume present is at or below one of the predetermined reorder level and the predetermined critical level.

In one embodiment of the present invention, processing the signal representative of the container level in the first at least one storage container into the material volume present comprises one of referencing the container level from a look-up table that correlates container level to material volume present, and calculating the material volume present from an algorithm based on the container level and container dimensions.

### BRIEF DESCRIPTION OF THE DRAWINGS

FIG. 1 is a flow chart of a method according to one embodiment of the present invention.

### DETAILED DESCRIPTION OF THE INVENTION

The present invention provides a method for managing the inventory of admixture and additive material for concrete, grout and mortar, in remote storage containers without the need for a person to repeatedly visit the location where the storage containers are located, to audit the inventory and place orders for additional material.

Certain admixtures and additives are used to modify the fluid properties of fresh concrete, mortar and grout, while others are used to modify hardened concrete, mortar, and grout. The various admixtures and additives that can be inventoried and monitored according to the methods of the present invention include, but are not limited to materials that can be used in concrete, mortar or grout for the following purposes: (1) to increase workability without increasing water content or to decrease the water content at the same workability: (2) to retard or accelerate the time of initial setting; (3) to reduce or prevent settlement of the finished material or to create slight expansion thereof; (4) to modify the rate and/or capacity for bleeding; (5) to reduce segregation of constituent ingredients; (6) to improve penetration and pumpability; (7) to reduce the rate of slump loss; (8) to retard or reduce heat evolution during early hardening; (9) to accelerate the rate of strength development at early stages; (10) to increase the strength of the finished material (compressive, tensile, or flexural); (11) to increase durability or resistance to severe conditions of atmospheric exposure, including application of deicing salts; (12 ) to decrease the capillary flow of water within the material; (13) to decrease permeability of the material to liquids; (14) to control expansion caused by the reaction of alkali with certain aggregate constituents; (15) to produce cellular concrete; (16) to increase the bonding of concrete to steel reinforcing elements; (17) to increase the bonding between old and new concrete; (18) to improve the impact resistance and abrasion resistance of finished materials; (19) to inhibit the corrosion of embedded metal; (20) to produce colored concrete or mortar; and (21) to introduce natural or synthetic fibers to reinforce concrete.

Admixtures and additives to which the methods of the present invention may be applied include, but are not limited to, those classes and types of admixtures designated in the following ASTM Standard Specifications: ASTM C 494, for Chemical Admixtures for Concrete, namely water reducing admixtures, retarding admixtures, accelerating admixtures, and their combinations; ASTM C 260, for Air Entraining Admixtures for Concrete; ASTM C 796 and 869 for Foaming Agents; ASTM G 109 for Chemical Admixtures for Corrosion; ASTM C 979 for Pigments for Integrally Colored Concrete; ASTM C 618, for Coal Fly Ash and Raw or Calcined Natural Pozzolan for Use as a Mineral Admixture in Concrete; ASTM C 989, for Ground Granulated Blast Furnace Slag for Use in Concrete and Mortars; and, ASTM C 1240, for Silica Fume for Use as a Mineral Admixture in Concrete, Mortar and Grout.

Admixtures and additives for concrete, grout and mortar, to which the methods of the present invention can be applied for remote inventory management are classified by function as set forth below. These liquid and solid materials are well known in the industry, by their chemistry and/or function.

Accelerators are used to accelerate the setting and early strength development of concrete.

Retarding, or delayed-setting, admixtures are used to retard, delay, or slow the rate of setting of concrete. Retarders are used to offset the accelerating effect of hot weather on the setting of concrete, or delay the initial set of concrete or grout when difficult conditions of placement occur, or problems of delivery to the job site, or to allow time for special finishing processes. Some retarders also act as water reducers, and some can also be used to entrain some air into concrete.

Antifreezing admixtures are capable of depressing the freezing point of water in concrete, and may be weak accelerators or retarders of cement setting and hardening.

Air detrainers are used to decrease the air content in the mixture of concrete.

Air-entraining admixtures are used to purposely entrain microscopic air bubbles into concrete. Air-entrainment dramatically improves the durability of concrete exposed to moisture during cycles of freezing and thawing. In addition, entrained air greatly improves a concrete's resistance to surface scaling caused by chemical deicers. Air entrainment also increases the workability of fresh concrete while eliminating or reducing segregation and bleeding.

Alkali-reactivity reducers can reduce alkali-aggregate expansion.

Anti-washout admixtures are cohesion-inducing materials that render concrete cohesive enough to allow limited exposure to water with little loss of cement.

Bonding admixtures are usually added to portland cement mixtures to increase the bond strength between old and new concrete.

Water-reducing admixtures are used to reduce the amount of mixing water required to produce concrete of a certain slump, to reduce the ratio of water and cement, or to increase slump.

Superplasticizers are high-range water reducers, or water-reducing admixtures. They are added to concrete to make high-slump flowing concrete, and thus reduce the water-cement ratio. These admixtures produce large water reduction or great flowability without causing undue set retardation or entrainment of air in mortar or concrete.

Natural and synthetic admixtures are used to color concrete for aesthetic and safety reasons. These coloring admixtures may be composed of pigments, multi-component admixtures that additionally influence the hydration reaction or morphology of the hydrated phase, and mortar coloring aids.

Corrosion inhibitors in concrete serve to protect embedded reinforcing steel from corrosion due to its highly alkaline nature. The high alkaline nature of the concrete causes a passive and non-corroding protective oxide film to form on the steel. However, carbonation or the presence of chloride ions from deicers or seawater can destroy or penetrate the film and result in corrosion. Corrosion-inhibiting admixtures chemically arrest this corrosion reaction.

Damp-proofing and waterproofing admixtures reduce the permeability of concrete that have low cement contents, high water-cement ratios, or a deficiency of fines in the aggregate. These admixtures retard moisture penetration into dry concrete.

Flocculating admixtures reduce bleeding (of water) in cementitious mixtures.

Grouting agents, such as air-entraining admixtures, accelerators, retarders, and non-shrink and workability agents, adjust grout properties to achieve a desired result for specific applications. For example, portland cement grouts are used for a variety of different purposes, each of which may require a different agent to stabilize foundations, set machine bases, fill cracks and joints in concrete work, cement oil wells, fill cores of masonry walls, and grout pre-stressing tendons and anchor bolts, and fill the voids in pre-placed aggregate concrete.

Gas formers, or gas-forming agents, are sometimes added to concrete and grout in very small quantities to cause a slight expansion prior to hardening. The amount of expansion is dependent upon the amount of gas-forming material used and the temperature of the fresh mixture.

Permeability reducers are used to reduce the rate at which water under pressure is transmitted through concrete.

Polymer modifiers for mortars and concretes are used to improve tensile and flexural strengths, adhesion, waterproofing, abrasion resistance and chemical resistance, and include latexes, redispersible polymer powders, water soluble polymers, liquid resins and monomers.

Pumping aids are added to concrete mixes to improve pumpability. These admixtures thicken the fluid concrete, i.e., increase its viscosity, to reduce de-watering of the paste while it is under pressure from the pump.

Bacteria and fungal growth on or in hardened concrete may be partially controlled through the use of fungicidal, germicidal, and insecticidal admixtures.

Finely divided mineral admixtures are materials in powder or pulverized form added to concrete before or during the mixing process to improve or change some of the plastic or hardened properties of portland cement concrete. Portland cement, as used in the trade, means a hydraulic cement produced by pulverizing clinker, consisting essentially of hydraulic calcium silicates, all usually containing one or more of the forms of calcium sulfate as an interground addition with ASTM types, I, II, III, IV, or V. The finely divided mineral admixtures can be classified according to their chemical or physical properties as: cementitious materials; pozzolans; pozzolanic and cementitious materials; and nominally inert materials. Cementitious materials are materials that alone have hydraulic cementing properties, and set and harden in the presence of water. Included in cementitious materials are ground granulated blast-furnace slag, natural cement, hydraulic hydrated lime, and combinations of these and other materials. Pozzolan is a siliceous or aluminosiliceous material that possesses little or no cementitious value but will, in the presence of water and in finely divided form, chemically react with the calcium hydroxide released by the hydration of portland cement to form materials with cementitious properties. Diatomaceous earth, opaline cherts, clays, shales, fly ash, silica fume, volcanic tuffs and pumicites are some of the known pozzolans. Certain ground granulated blast-furnace slags and high calcium fly ashes possess both pozzolanic and cementitious properties. Nominally inert materials can also include finely divided raw quartz, dolomites, limestones, marble, granite, and others.

In the construction field, one current method of strengthening concrete involves distributing fibers throughout a fresh concrete mixture, such as fibers made of zirconium materials, steel, fiberglass, or synthetic materials, e.g., polypropylene, nylon, polyethylene, polyester, rayon, high-strength aramid, (i.e. Kevlar®), or mixtures thereof.

In a typical concrete mixing facility, several storage tanks and/or silos are located on site, each dedicated to a specific type of admixture or additive material. The present invention provides the ability to measure the amount of admixture and additive material for concrete, grout and mortar in storage containers at these facilities, which are locations remote to the admixture and additive supplier, to provide real time inventory control. Depending upon the volume of material in inventory, additional material can be ordered and shipped to the storage containers to add additional material to the storage containers. The storage containers are inventoried periodically to determine if additional material is needed. The inventory volume at these periodic intervals can be stored in a database to provide a usage history for the material in the storage container.

The stored information can then be used to better plan for utilization of the storage container. Advantageously, this information can be made available to appropriate personnel to aid them in planning and sales. This information can also be made available to the users of the storage containers. The information can be manipulated by different personnel for different uses.

Information such as usage history can be used to develop and/or modify rules for the inventory management system, including but not limited to the appropriate normal reorder level for each storage container based upon normal usage patterns, critical levels for each storage container at which point shipment becomes a priority due to material demand, and alternate ordering levels for materials whose demand fluctuates seasonally.

For example, users of the admixture and additive material can reduce “safety” stock levels resulting in an opportunity to run their business at overall lower levels of inventory. Additionally, the information could be used to monitor the storage container integrity and provide an alert if the level were to change by more than a fixed amount within a specified period of time.

For customers with multiple locations or large geographic coverage, the present invention permits not only the local plant to have the ability to monitor, in real time, its admixture usage and inventory levels, but also the appropriate staff at headquarters can monitor inventory at any single location or for the entire company.

The methods of the present invention enable the provider of admixture and additive material, for concrete, grout and mortar, to automate large portions of the process, including ordering, order confirmation, expediting, delivery scheduling, delivery confirmation, and invoicing, with resulting significant impacts on efficiency, reliability and costs. The inventive method allows the sales representative to focus time and energy on providing technical input and promoting value added concrete, while easily monitoring product inventory and delivery.

To practice the methods of the present invention, a level indicator is placed on the storage container. The level indicator can be any appropriate level indicator that can translate the level measurement into an electronic signal. For storage containers containing liquids, appropriate electronic level indicators include, but are not limited to, pressure transducers, ultrasonic transducers, capacitors, conductivity sensors, and floats. A preferred electronic level indicator utilizes ultrasonic transducers. For storage containers containing solids, appropriate electronic level indicators include, but are not limited to, ultrasonic transducers.

In operation, the level indicator in each container is activated and measures the level of the respective container, receiving a return signal representative of the level of the material, and sends the resulting return signal to a processor. Preferably once a day, but more or less often depending upon usage of the material, the processor can receive and store the level signal from the level indicator for later transmission to a second processor that calculates the volume. Alternatively, the processor can convert the signal from the level indicator into an actual volume measurement by either referencing a look-up table that cross references level to volume information, or by calculating the volume from an algorithm based on the physical dimension of the container and the material level in the container.

Preferably, all of the information for a given location having remote storage containers goes to a central processor at that site. Either the level or the calculated volume is transmitted to a second processor. The transmission can be by any known means of transmitting signals. Preferably, the signal is transmitted via cellemetry or by satellite.

U.S. Pat. No. 5,873,043, which is incorporated herein by reference, U.S. Pat. No. 6,014,089, which is incorporated herein by reference, and U.S. Pat. No. 5,787,149, which is incorporated herein by reference, disclose methods of transmitting data via cellemetry. Generally, cellemetry transmits on the non-voice or control channel of cellular systems.

Cellemetry is a low-overhead cellular radio communication scheme that allows for transfer of real-time, remote data through a standard cellular telephone network. More specifically, by this technique, the first processor and second processor communicate with each other by using the under-utilized frequency bands allocated to control channels of the cellular system. Control channels are utilized by the cellular telephone industry for transmitting control data between the switching facilities and cellular telephones. For example, cellular telephone networks utilize control channels to determine the “cell” (i.e., the geographic region) in which the cellular telephones operate. This determination provides the switching facilities with adequate response time to route the transmitted signals to the transmitting tower of the appropriate cell.

Transmitting via satellite is similar to transmitting via cellemetry. Instead of a cellular transmitter, a satellite transmitter is used to transmit information to a satellite. The satellite has the same function as the cellular tower.

The data is transmitted via an electronic signal as described above to a monitoring station, preferably at a predetermined time periodically, such as daily or weekly.

The monitoring station, which may contain the second processor, receives and converts the signal to data to be stored in a secure database, which data may include identifying the location of the storage container, total volume of the storage container, identity of the contents, amount of material in the container, and various desired customer data, such as a predetermined product reorder level, a product critical level, and an emergency response triggering level. The database is associated with the second processor, in that the database can be accessed by the second processor, at least to modify the database by adding, modifying or deleting data. It is possible, but not necessary, that the database be stored in a digital storage medium or device dedicated to the second processor, as the database may be resident on a remote computer or computer network.

The database can be queried remotely via authorized access via computer modem and/or via a global computer network, such as the internet, an intranet, a virtual private network, private computer network, or dedicated modem, and optionally by telephone. For example, a specified telephone number can be dialed to receive a voice-generated update for each selected site. This enables authorized personnel without computers to check inventory at their assigned locations. It also serves as a back up to internet access when a provider goes off line for a few hours.

Access to the database can be regulated so that a password is required to access information, and optionally encryption can be utilized to secure data or to access it. The level of access can be selected for each authorized user based on a clearance level, such as in a pyramid structure in a corporate organization. For example, sales personnel can be given access to information on storage containers that they are specifically responsible for. District managers could access information on storage containers for the sales personnel that report to them. The main sales manager could access information for all storage containers. Optionally, customers of the storage containers could be given access for their specific, leased storage containers. As an option, selected information can be transmitted automatically or on demand to appropriate personnel via e-mail, pager, voice mail, and the like.

The database can indicate the time and date of the last update for the remote storage container, the number of containers at critical, reorder, or emergency level, and the history for each storage container. Also, the history of all storage containers at a given location can be stored in and accessed from the database. Further, the identity of manufacturing and/or distribution sites that can supply the storage containers may be stored and updated periodically or in real time.

The database also allows tracking of usage of a given material in a given geographic region. By reviewing the usage in remote storage containers for a geographic region for a specific material, the usage of that material in that geographic region can be tracked. This allows for better production planning when manufacturing the admixture or additive material.

In one embodiment of the method of the invention, a remote computer connects to an FTP site on a global computer network. The database system checks for authorization and security clearance level to allow the remote computer access to the database. Preferably, the access to the database is validated by the IP address of the querying computer. The remote computer is updated with any new or appended files containing inventory information since its last connection with the FTP site. The remote computer user can then review the material levels in the remote storage containers. If needed, the remote user can generate orders for shipments to deliver additional material to the remote storage containers.

Orders can be placed based on level, such as reorder, critical, or capacity to accommodate excess material. The reorder level is the level at which an order would be placed during the normal course of business. The reorder level can vary throughout the year based on seasonal changes in the demand for the material in the storage container. The critical level is the level at which material would be needed in a short time in order to prevent running out of material.

In one embodiment, a user that is accessing the database can create an order. The order can be a predetermined amount based on historical shipments to the storage container, or based on critical amounts. In this event, a prospective order can be generated automatically (by computer software), optionally to await manual authorization (from sales personnel or customer) before actually submitting the order. Also, the amount of the order can be manually selected. When creating the order, the distribution location, such as a manufacturing plant or a storage facility, can be preselected automatically or selected manually to ship the material to the remote storage container. Generally, a remote storage container will be supplied from a given distribution location, but this could change depending upon several factors, such as current supply at the distribution location or manufacturing schedule. Once the user confirms the amount of material and the distribution location, the order is created.

The automatic entry into the database of material volumes in the remote storage containers and the automatic creation of prospective orders reduces the amount of manual input of order information. This results in fewer errors, and allows personnel to become more productive.

Occasionally, conditions change between the time material is ordered and the time material is delivered. An order may be placed based on predicted use of material, which may change. This is a problem in the concrete admixture and additives industry. There may be a plan to use material, but weather or other factors delay the use of the material. If this happens when an order of material is already shipped, up to the entire quantity of material shipped may not fit in the open volume of the storage container. In the past, this overage of material was most likely returned back to the shipping point, incurring additional freight costs.

The inventory management system of the present invention allows a person to access information on other storage containers in the same geographic area that contain a similar material. Excess undelivered material can be redirected to one of these other storage containers so that the material does not have to be returned to the shipping point. Without the inventory management system, there is no guarantee of determining an up to date volume measurement in the relevant storage containers. Time and effort must be expended in contacting personnel to check other storage containers to determine if these other storage containers had open volume to accommodate the excess material. In the past, it could not be determined if other storage containers were available, and the excess material was returned to the shipping point.

Also, freight costs can be saved by sending full shipments of materials from manufacturing or distribution locations, even though a full shipment of material may not be able to be delivered to a single, specific storage container. For example, if material is being shipped to a storage container in a given geographic area, a full shipment can be made to the geographic area even though that one specific storage container may not have capacity to hold the full amount of the shipment, if other storage containers in the geographic area may be able to accommodate the excess amount. This consolidated shipping can reduce the number of shipments to a given geographic area.

In determining where excess material could be delivered, the inventory management system is able to recall the last volume measurement for other potential shipping point storage containers, or alternatively, a command could be sent to the other storage containers to measure the level in the containers and to transmit data representing the current volumes in the storage containers.

Additionally, the inventory management system can monitor emergency situations, such as a breakage or leakage in the storage container. The system can monitor when the volume level of the material in the storage container drops precipitously or faster than plausible usage levels, or when the volume level drops during a period of time when the material in the storage container is not being used. A warning can be generated by the system to alert personnel to inspect the storage container. This emergency level can be referenced from a look up table or can be calculated. Generally, an emergency level is the removal of material from the remote storage container that is greater than about two standard deviations of daily usage.

The database can be tailored to display any desired combination of data. For example, the database can display all storage containers that are at a critical level or a reorder level so that action can be taken. Orders can be manually (that is, with the intervention of a human operator) or automatically generated to deliver material to these storage containers. The volume capacity of the storage containers can also be maintained in the database. This can be used to determine how much material can be delivered to the storage container based on the current material volume of the storage container. Also, the database can display the storage container status for all storage containers in a given geographic area for a given material.

When material is to be shipped to a storage container, an order is generated and sent to a location where material is stored. Material could be stored at the site where it was manufactured or at any other location. When the order is generated, transportation is arranged to transport the material to the storage container.

Optionally, the volume of material in the containers where material is stored for shipment, i.e., at manufacturing or distribution centers, can also be included in the inventory management system. Level indicators can be installed on these containers. The level or volume in these containers can then be similarly transmitted to the database. This could aid in determining from which manufacturing or distribution location to ship material, and to determine if additional material needs to be manufactured.

After the order is placed, the material is then transported to the storage container, where it is unloaded into the storage container. The amount of material that was actually unloaded into the storage container is recorded as the amount delivered. As described above, the amount actually unloaded may be less than the amount shipped if there was insufficient space in the storage container to unload the entire amount shipped. Information about the amount of material delivered is optionally transferred to a billing system (manually or automatically). The transfer to the billing system can be via an electronic signal transmitted via cellemetry, satellite, or phone, or it can be by any other means such as by paper, that is later converted into electronic data.

Optionally, the delivered amount of material can be confirmed by sending a signal to the level indicator to measure the material level in the remote storage container and returning a signal representative of the material level or material volume in the remote storage container.

Once the delivered amount reaches the billing system, an invoice is generated and sent to the customer. Preferably, the invoice is transmitted via an electronic means, but any suitable means may be used. The customer can pay the invoice by sending a payment. In a preferred embodiment, the payment is sent by electronic funds transfer, and is recorded electronically.

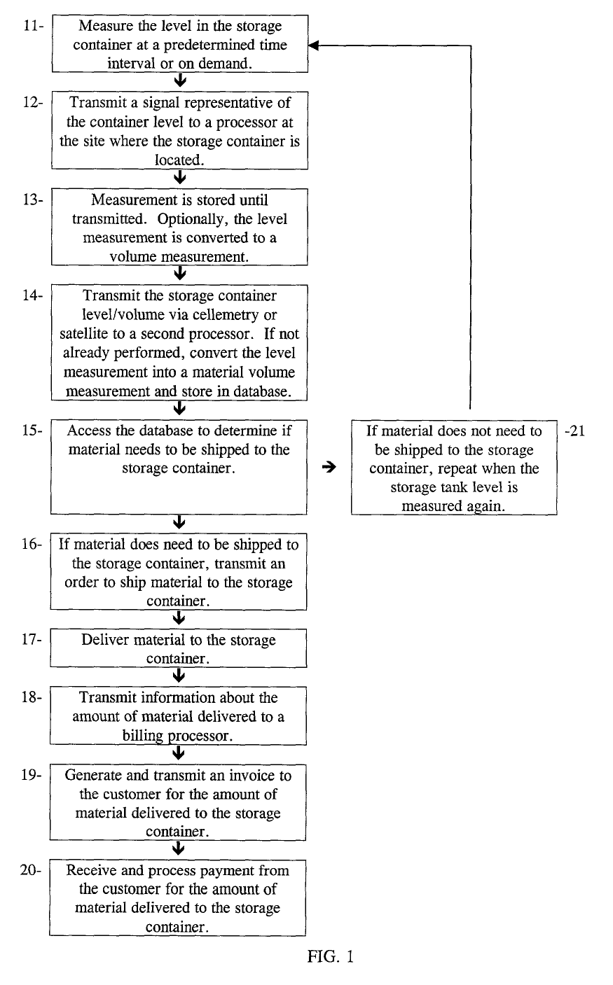

FIG. 1 illustrates the general steps in a preferred embodiment of the present invention. The level in the storage container is measured at a predetermined time interval or on demand 11. A signal representative of the container level is transmitted to a processor at the site where the storage container is located 12. The measurement is stored until transmitted 13. Optionally, the level measurement is converted to a volume measurement. The storage container level/volume is transmitted via cellemetry or satellite to a second processor 14. If not already performed, the level measurement is converted into a material volume measurement and stored in database. The database is accessed to determine if material needs to be shipped to the storage container 15. If material does not need to be shipped to the storage container, repeat the process when the storage container level is measured again 21. If material does need to be shipped to the storage container, an order is transmitted to ship material to the storage container 16. Material is delivered to the storage container 17. Information is transmitted about the amount of material delivered to a billing processor 18. An invoice is generated and transmitted to the customer for the amount of material delivered to the storage container 19. Payment is received and processed from the customer for the amount of material delivered to the storage container 20.

The methods of the present invention utilize technology and business systems to produce a seamless flow of information. This information includes, among others, up to date and “real time” inventory level of admixtures and additives for concrete, mortar and grout at customer locations, low cost order fulfillment options, and facilitated invoicing and payment procedures while improving sales resource productivity. One advantage of the inventive inventory management system is the ability to track amounts of material usage over time. Advantageously, the database can provide the history of any given shipment to authorized users. This can provide information and reports on seasonal demand for individual materials in each storage container, and the production of materials for shipment. Using this information, more appropriate ordering can be generated derived from more accurately determined reorder levels based on seasonal variations. Also, more accurate forecasts can be made to determine material to be produced.

The methods of the present invention permit optimizing delivery routing and reduction of product returns to the manufacturing plants or distribution sites, reduction of unscheduled emergency shipments resulting from unmonitored and/or limited storage of inventory at customers' facilities, reducing field transfers of inventory, reducing or eliminating customer site visits for the sole purpose of inventory status, and establishing minimum inventory levels. The methods of the present invention permit the integration and automation of inventory database, order placement and fulfillment, and accounts receivable operations. In preferred embodiments of the invention, the automatic generation of an order is triggered by the measurement of the material volume present in a storage container at the reorder or critical level, and the automatic preparation and transmission of an invoice is triggered by the receipt of a transmission of a confirmation of delivery of a shipment of material, optionally with preauthorized electronic debiting or transfer of payment.

It should be appreciated that the present invention is not limited to the specific embodiments described above, but includes variations, modifications and equivalent embodiments defined by the following claims.

What is claimed is:

1. A method of managing inventory of admixture and additive material for concrete, grout and mortar remotely, comprising:
a. inventorying a first at least one storage container of material at a remote site to provide a material volume present comprising:
i) measuring a level of material in the first at least one storage container with an electronic level indicator to provide a signal representative of the container level;
ii) transmitting the signal representative of the container level from the electronic level indicator to a first processor;
wherein said measuring is performed at one of a preset time and on demand; performing one of step b or step c:
b. i) processing the signal representative of the container level to determine the material volume present in the first at least one storage container; and
ii) transmitting data representing the material volume present in the first at least one storage container from the first processor to a second processor via one of cellemetry and satellite; or
c. i) transmitting the signal representative of the container level in the first at least one storage container from the first processor to a second processor via one of cellemetry and satellite; and
ii) processing the signal representative of the container level to determine the material volume present in the first at least one storage container; and
d. storing data representing the material volume present, a predetermined reorder level, and a predetermined critical level in a database associated with the second processor.

2. The method of claim 1 further comprising querying the database to determine if material needs to be shipped to the first at least one storage container based on the material volume present.

3. The method of claim 2 further comprising generating an order to ship material to the first at least one storage container, and transmitting the order to ship material automatically or after authorization.

4. The method of claim 3, wherein the generating the order to ship material occurs if the material volume present is at or below one of the predetermined reorder level and the predetermined critical level.

5. The method of claim 3 further comprising delivering the material to the first at least one storage container.

6. The method of claim 1, wherein processing the signal representative of the container level in the first at least one storage container into the material volume present comprises one of referencing the container level from a look-up table that correlates container level to material volume present, and calculating the material volume present from an algorithm based on the container level and container dimensions.

7. The method of claim 1 further comprising storing data representing the container level of the at least one storage container for subsequent transmission to the second processor.

8. The method of claim 1, wherein the electronic level indicator is one of a ultrasonic transducer and a pressure transducer.

9. The method of claim 1, wherein the storing in the second processor further comprises transferring the data representing the material volume present in the at least one storage container from the second processor to a database in a computer on a site on a global computer network, wherein the site is electronically accessible by authorized individuals.

10. The method of claim 9 further comprising accessing the site on the global computer network to retrieve the data representing the material volume present in the at least one storage container.

11. The method of claim 10, wherein access is validated by the IP address of the querying computer.

12. The method of claim 10, wherein the accessing is protected by at least one of passwording and encryption.

13. The method of claim 12, wherein the passwording limits access to the data representing the material volume present in the at least one storage container based on the authorized individual's level of access authority.

14. The method of claim 9 further comprising electronically connecting a remote computer to the site on the global computer network, checking for authorization and security clearance level to allow the remote computer access to the database, and updating the remote computer with new or appended files containing inventory information since the remote computer was last connected to the site on the global computer network.

15. The method of claim 14, wherein the checking is validated by the IP address of the remote computer.

16. The method of claim 14 further comprising generating an order to ship material to the at least one storage container.

17. The method of claim 1 further comprising accessing the database to retrieve the data representing the material volume present in the at least one storage container via at least one of: a voice interface through a telephonic connection, a virtual private network, an intranet, a private computer network, and a personal computer through a dedicated modem.

18. The method of claim 17, wherein the accessing is protected by passwording to limit access to the data representing the material volume present in the at least one storage container.

19. The method of claim 17, wherein the passwording limits access to the data representing the material volume present in the at least one storage container based on the authorized individual's level of access authority.

20. The method of claim 3 including selecting a manufacturing or distribution site for shipping the order of material to the at least one storage container if the material volume content of the at least one distribution storage container associated with said site is sufficient.

21. The method of claim 1 further comprising:
a. inventorying at least one distribution storage container of material to provide a distribution storage container material volume content comprising:
i) measuring a level of material in the at least one distribution storage container with an electronic level indicator to provide a signal representative of the distribution storage container level;
ii) transmitting the signal representative of the distribution storage container level from the electronic level indicator to a third processor;
wherein said measuring is performed at one of a preset time and on demand; performing one of step b or step c:
b. i) processing the signal representative of the distribution storage container level to determine the material volume content of the at least one distribution storage container; and
ii) transmitting data representing the material volume content of the first at least one distribution storage container from the third processor to the second processor via one of cellemetry and satellite; or
c. i) transmitting the signal representative of the distribution storage container level from the third processor to the second processor via one of cellemety and satellite; and
ii) processing the signal representative of the distribution storage container level to determine the material volume content of the distribution storage container; and
d. storing the distribution storage container material volume content in the database associated with the second processor.

22. The method of claim 21 further comprising querying the database to determine the material volume content of the at least one distribution storage container.

23. The method of claim 5, wherein delivering the material involves an amount of material shipped that is in excess of the amount of material that can be accommodated by the first at least one storage container, further comprising querying the database to identify a second at least one storage container at another location able to accommodate at least a portion of the excess material for shipping the excess material thereto.

24. The method of claim 5 further comprising transmitting information representative of the amount of material delivered to a billing processor.

25. The method of claim 24, wherein the transmitting is performed electronically, optionally via one of cellemetry and satellite.

26. The method of claim 24 further comprising transmitting an invoice to the customer.

27. The method of claim 26, wherein the invoice is in one of an electronic format and paper format.

28. The method of claim 26 further comprising processing a payment from the customer.

29. The method of claim 28, wherein the payment is an electronic funds transfer.

30. The method of claim 1, wherein the database indicates at least one of:
a. time and date of when the at least one storage container was inventoried;
b. the identity of which at least one storage container is at the predetermined reorder level, the predetermined critical level, or an emergency level;
c. a history of the material volume present in the at least one storage container over time;
d. a usage of a given material in a given geographic region; and
e. a selection of distribution storage container sites having a material volume content sufficient to ship material to the at least one storage container.
